(19) United States
(12) Patent Application Publication
(10) Pub. No.: US 2026/0253054 A1
(43) Pub. Date: Aug. 27, 2026

(54) PRODUCT CONFIRMATION APPARATUS, PRODUCT CONFIRMATION METHOD, AND NON-TRANSITORY COMPUTER-READABLE STORAGE MEDIUM

(71) Applicant: NEC Corporation, Minato-ku, Tokyo (JP)

(72) Inventors: Soma Shiraishi, Tokyo (JP); Takami Sato, Tokyo (JP); Tomokazu Kaneko, Tokyo (JP)

(73) Assignee: NEC Corporation, Minato-ku, Tokyo (JP)

(21) Appl. No.: 18/726,454

(22) PCT Filed: Mar. 16, 2022
(86) PCT No.: PCT/JP2022/011899

§ 371 Date: Jul. 3, 2024

(51) Int. Cl. G06Q 20/20; G06Q 20/42; G06Q 30/018

(52) U.S. Cl. CPC G06Q 20/208; G06Q 20/42; G06Q 30/0185

(57) ABSTRACT

A first acquisition unit (110) acquires, from a product to be a payment target, product identification information of the product through a reading apparatus. A second acquisition unit (120) acquires a first image. The first image is an image generated when the reading apparatus reads the product identification information, and includes the product to be a payment target. A read-out unit (130) reads, from a storage unit storing appearance information indicating an appearance of the product and the product identification information of the product in association with each other, the appearance information relevant to the product identification information acquired by the first acquisition unit (110). An execution unit (140) executes first processing when a difference between the appearance information read by the read-out unit (130) and appearance information of the product based on the first image acquired by the second acquisition unit (120) satisfies a first criterion.

### TECHNICAL FIELD

The present invention relates to a product confirmation apparatus, a product confirmation method, and a storage medium.

### BACKGROUND ART

In recent years, it has been considered to, when paying for a product, acquire and process an image of the product, and utilize a result of the processing.

For example, Patent Document 1 discloses a system that generates data for learning, in a neural network that performs recognition of a product by use of a captured image captured with a camera. Specifically, a server extracts, from among captured images each received from the camera, a captured image captured at a time close to a scan time of a barcode of each product.

Subsequently, the server cuts out a product image in the extracted captured image, and labels each of the product images that have been cut out, with a JAN code relevant to a barcode scanned at a scan time closest to a capture time of a captured image to be a base of each of the product images, among JAN codes received from a POS register.

Moreover, Patent Document 2 discloses a system having the following function. First, an object recognition unit recognizes an object from an image including the object as a subject. A product determination unit determines the object as a product by use of a technique such as image recognition. A visual inspection result acquisition unit transmits the image to a terminal for visual inspection, and acquires a result of the determination of the product by visual inspection transmitted from the visual inspection terminal. A payment unit performs payment processing regarding the product determined based on results of the product determination unit and the visual inspection result acquisition unit.

### RELATED DOCUMENTS

### Patent Documents

Patent Document 1: Japanese Patent Application Publication No. 2020-095537
Patent Document 2: Japanese Patent Application Publication No. 2020-061044

### SUMMARY OF INVENTION

### Technical Problem

When determining a product by image recognition, it is necessary to previously store an image to be a criterion in a storage unit. However, the registration processing requires effort. Methods described in Patent Documents 1 and 2 cannot solve this problem.

In view of the problem described above, one example of an object of the present invention is to provide a product confirmation apparatus, a product confirmation method, and a storage medium in which effort when storing an image to be criterion in a storage unit is less in a case where a product is determined by image recognition.

### Solution to Problem

According to one aspect of the present invention, there is provided a product confirmation apparatus including:
a first acquisition unit that acquires, from a product to be a payment target, product identification information of the product through a reading apparatus;
a second acquisition unit that acquires a first image being an image generated when the reading apparatus reads the product identification information, and including the product;
a read-out unit that reads, from a storage unit storing appearance information indicating an appearance of the product and the product identification information of the product in association with each other, the appearance information relevant to the product identification information acquired by the first acquisition unit; and
an execution unit that executes first processing when a difference between the appearance information read by the read-out unit and appearance information of the product based on the first image acquired by the second acquisition unit satisfies a first criterion, wherein
at least a part of pieces of information stored in the storage unit is generated by use of the product identification information acquired by the first acquisition unit and the first image acquired by the second acquisition unit.

According to one aspect of the present invention, there is provided a product confirmation method including,
by a computer:
   acquiring, from a product to be a payment target, product identification information of the product through a reading apparatus;
   acquiring a first image being an image generated when the reading apparatus reads the product identification information, and including the product;
   reading, from a storage unit storing appearance information indicating an appearance of the product and the product identification information of the product in association with each other, the appearance information relevant to the product identification information acquired by the computer; and
   executing first processing when a difference between the appearance information read by the computer and appearance information of the product based on the first image acquired by the computer satisfies a first criterion, wherein
at least a part of pieces of information stored in the storage unit is generated by use of the product identification information acquired by the computer and the first image acquired by the computer.

According to one aspect of the present invention, there is provided a storage medium storing a program executable by a computer,
the program causing the computer to include:
   a first acquisition function of acquiring, from a product to be a payment target, product identification information of the product through a reading apparatus;
   a second acquisition function of acquiring a first image being an image generated when the reading apparatus reads the product identification information, and including the product;
   a read-out function of reading, from a storage unit storing appearance information indicating an appearance of the product and the product identification information of the product in association with each other, the appearance information relevant to the product identification information acquired by the first acquisition function; and
   an execution function of executing first processing when a difference between the appearance information read by the read-out function and appearance information of the product based on the first image acquired by the second acquisition function satisfies a first criterion, wherein
at least a part of pieces of information stored in the storage unit is generated by use of the product identification information acquired by the first acquisition function and the first image acquired by the second acquisition function.

### Advantageous Effects of Invention

According to one aspect of the present invention, a product confirmation apparatus, a product confirmation method, and a storage medium in which effort when storing an image to be criterion in a storage unit is less in a case where a product is determined by image recognition can be provided.

### BRIEF DESCRIPTION OF THE DRAWINGS

FIG. 1 It is a diagram illustrating an outline of a product confirmation apparatus according to an example embodiment.

FIG. 2 It is a diagram for describing a use environment of the product confirmation apparatus.

FIG. 3 It is a diagram illustrating one example of a functional configuration of the product confirmation apparatus.

FIG. 4 It is a diagram illustrating one example of information stored in a storage unit.

FIG. 5 It is a diagram illustrating a hardware configuration example of the product confirmation apparatus.

FIG. 6 It is a flowchart illustrating one example of processing that the product confirmation apparatus performs.

FIG. 7 It is a diagram illustrating a modified example of FIG. 6.

### EXAMPLE EMBODIMENT

Hereinafter, an example embodiment of the present invention is described by use of the drawings. Note that, a similar reference sign is assigned to a similar component in all the drawings, and description is not included as appropriate.

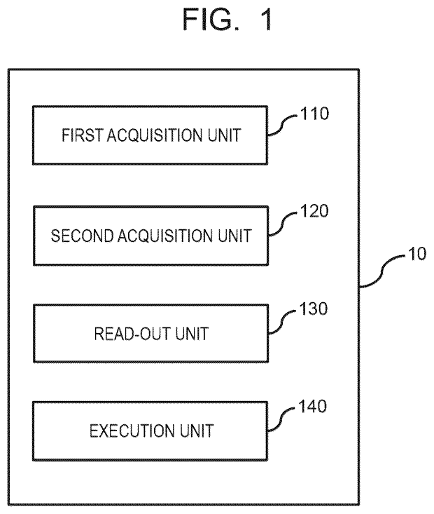

FIG. 1 is a diagram illustrating an outline of a product confirmation apparatus 10 according to an example embodiment. The product confirmation apparatus 10 includes a first acquisition unit 110, a second acquisition unit 120, a read-out unit 130, and an execution unit 140. The first acquisition unit 110 acquires, from a product to be a payment target, product identification information of the product through a reading apparatus. The second acquisition unit 120 acquires a first image. The first image is an image generated when the reading apparatus reads the product identification information, and includes the product to be a payment target. The read-out unit 130 reads, from a storage unit storing appearance information indicating an appearance of the product and the product identification information of the product in association with each other, the appearance information relevant to the product identification information acquired by the first acquisition unit 110. The execution unit 140 executes first processing when a difference between the appearance information read by the read-out unit 130 and the appearance information of the product based on the first image acquired by the second acquisition unit 120 satisfies a first criterion.

Moreover, at least a part of pieces of information stored in the storage unit is generated by use of the product identification information acquired by the first acquisition unit and the first image acquired by the second acquisition unit. Thus, effort when storing appearance information and product identification information in the storage unit is less.

Hereinafter, a detailed example of the product confirmation apparatus 10 is described.

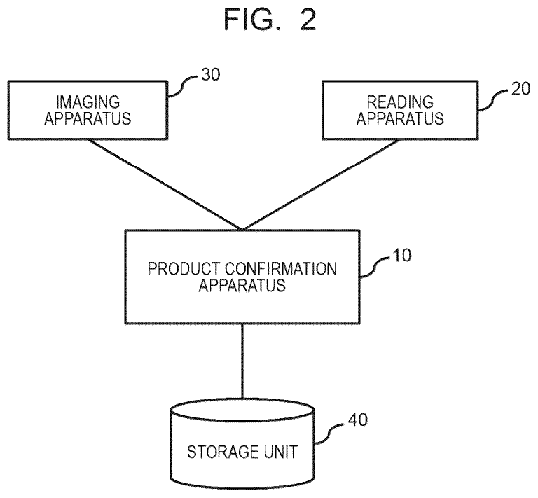

FIG. 2 is a diagram for describing a use environment of the product confirmation apparatus 10. The product confirmation apparatus 10 is installed in a store or an office. When the product confirmation apparatus 10 is installed in a store, a customer entering the store operates the product confirmation apparatus 10 when purchasing a product. On the other hand, when the product confirmation apparatus 10 is installed in an office, a product is displayed in a corner of the office. Then, a person working in the office operates the product confirmation apparatus 10 when purchasing the product.

The product confirmation apparatus 10 is used together with a reading apparatus 20, an imaging apparatus 30, and a storage unit 40. In the example illustrated in the present figure, the product confirmation apparatus 10 is used when a customer purchases a product, and includes a product registration function and a payment function. Note that, the product confirmation apparatus 10 may not have a payment function. In this case, the product confirmation apparatus 10 transmits, to the payment apparatus, information indicating a registered product.

The reading apparatus 20 acquires product identification information from a product that a customer is about to purchase i.e. a product to be a payment target. The reading apparatus 20 may acquire product identification information by reading a code, for example, a bar code or a two-dimensional code attached to the product, or may acquire product identification information from a wireless communication tag, for example, an RFID tag attached to the product. The reading apparatus 20 transmits the acquired product identification information to the product confirmation apparatus 10. In this instance, the reading apparatus 20 also transmits, to the product confirmation apparatus 10, information indicating acquisition timing of the product identification information, for example, acquisition date and time information. Hereinafter, the information is referred to as first timing information. The first timing information may be generated by the product confirmation apparatus 10. In this case, the product confirmation apparatus 10 generates first timing information in such a way as to indicate timing at which the product identification information is acquired from the reading apparatus 20.

Note that, the reading apparatus 20 may be integrated with the product confirmation apparatus 10.

When the reading apparatus 20 is acquiring product identification information from a product, the imaging apparatus 30 captures the product, and generates a first image. The imaging apparatus 30 may constantly generate an image, or may generate an image with acquisition of product identification information by the reading apparatus 20 as a trigger. A frame rate of the imaging apparatus 30 in the former case is, for example, equal to or more than 1 pfs and 30 pfs, but is not limited thereto.

Note that, the imaging apparatus 30 may be attached to the product confirmation apparatus 10, or may be attached above the product confirmation apparatus 10, for example, on a ceiling thereof.

An imaging range of the imaging apparatus 30 includes a region where a product is arrangeable when the reading apparatus 20 acquires product identification information, i.e. a product reading region. The imaging range may include the reading apparatus 20. Moreover, the imaging range may include a region around the product reading region. In this case, the imaging range preferably includes at least one of a region through which a product passes when the product moves toward the product reading region, and a region through which a product passes when the product moves outside the product reading region. Then, the imaging apparatus 30 makes the generated image the product confirmation apparatus 10. At least a part of the images transmitted herein is the first image described above. In this instance, the imaging apparatus 30 also transmits information indicating generation timing of the image, for example, generation date and time information, to the product confirmation apparatus 10. Hereinafter, the information is referred to as second timing information.

The storage unit 40 stores, for each of a plurality of products, product identification information, a price, and appearance information in association with each other. As described by use of FIG. 1, the appearance information is used when a product included in the first image generated by the imaging apparatus 30 is confirmed. The storage unit 40 preferably stores a plurality of pieces of appearance information. Then, product identification information and appearance information are generated by use of the product identification information acquired by the first acquisition unit and the first image acquired by the second acquisition unit. The storage unit 40 may be, for example, a server installed in a store where the product confirmation apparatus 10 is arranged.

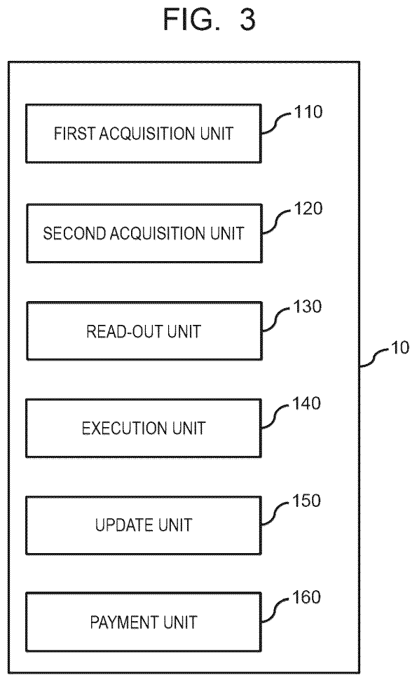

FIG. 3 is a diagram illustrating one example of a functional configuration of the product confirmation apparatus 10. As described by use of FIG. 1, the product confirmation apparatus 10 includes the first acquisition unit 110, the second acquisition unit 120, the read-out unit 130, and the execution unit 140. In the example illustrated in the present figure, the product confirmation apparatus 10 further includes an update unit 150 and a payment unit 160.

The first acquisition unit 110 acquires product identification information from the reading apparatus 20. In this instance, the first acquisition unit 110 also acquires first timing information. The first acquisition unit 110 generates registration information indicating a product to be a payment target.

The second acquisition unit 120 acquires an image generated by the imaging apparatus 30. In this instance, the second acquisition unit 120 also acquires the second timing information.

When the imaging apparatus 30 generates an image with acquisition of product identification information by the reading apparatus 20 as a trigger, the image acquired by the second acquisition unit 120 is an image generated when the reading apparatus 20 reads product identification information, i.e. the first image.

On the other hand, when the imaging apparatus 30 is constantly operating, an image acquired by the second acquisition unit 120 includes the first image and another image. Then, the second acquisition unit 120 determines an image having the second timing information closest to the first timing information as the first image relevant to the product identification information acquired by the first acquisition unit 110. Herein, for the first timing information and the second timing information, three cases can be conceived: a case of indicating the same timing, a case where the first timing information is earlier, and a case where the second timing information is earlier. In each case, a difference between the first timing information and the second timing information is, for example, equal to or less than one second.

The read-out unit 130 reads, from the storage unit 40, appearance information relevant to the product identification information acquired by the first acquisition unit 110. The appearance information may be an image itself, or may be a feature value generated based on the image. In the latter case, the appearance information includes a plurality of feature values.

The execution unit 140 computes a difference between the appearance information read by the read-out unit 130 and appearance information of a product based on the first image acquired by the second acquisition unit 120. For example, when the appearance information is an image, the execution unit 140 computes a difference among values of a plurality of pixels each included in a region corresponding to the product within the image. Moreover, when appearance information includes a plurality of feature values, the execution unit 140 generates appearance information by processing a region corresponding to a product within the first image. Then, the execution unit 140 computes, for example, a distance between two pieces of appearance information in a feature value space, as a difference between the two pieces of appearance information. Note that, the execution unit 140 may determine a sum or an average value of the differences between feature values, as a difference between two pieces of appearance information.

Note that, the first image may include a plurality of products. In this case, the execution unit 140 determines, as a target product, a product with the shortest distance to the reading apparatus 20.

Then, the execution unit 140 executes first processing when the computed difference satisfies a first criterion. Satisfying the first criterion indicates that there is a possibility that a product relevant to the appearance information read by the read-out unit 130 and a product included in the first image acquired by the second acquisition unit 120 are different. Then, one example of the first processing is output processing of warning information. The execution unit 140 may output the warning information to a display or a speaker included in the product confirmation apparatus 10, or may output the warning information to a terminal operated by a manager who manages sales of a product, for example, a terminal operated by a clerk of a store.

Note that, it is desirable that the storage unit 40 store a plurality of pieces of appearance information for one piece of product identification information. In this case, the read-out unit 130 reads the pieces of appearance information from the storage unit 40. Then, the execution unit 140 computes, for each of the plurality of pieces of appearance information, a difference between the appearance information and appearance information of a product based on the first image acquired by the second acquisition unit 120. Then, it is assessed whether a result of performing statistical processing of the plurality of differences satisfies the first criterion. One example of statistical processing performed herein is computation of an average value, determination of the largest difference, or determination of the smallest difference, but is not limited thereto. Moreover, in the statistical processing, a weighting coefficient may be set for each of a plurality of pieces of appearance information. In this case, the storage unit 40 stores the weighting coefficient.

One example of a computation method of the weighting coefficient is described. Appearance information stored in the storage unit 40 is generated by use of product identification information acquired by the first acquisition unit 110 and the first image acquired by the reading apparatus 20. Before the storage unit 40 stores the appearance information, the execution unit 140 performs an assessment of whether the first criterion is satisfied for the first image being a base of the appearance information. In this instance, the execution unit 140 computes a difference between appearance information based on the first image and appearance information stored in the storage unit 40 at the time. The update unit 150 may set a weighting coefficient, based on the difference. When the difference is large, the weighting coefficient is small. Note that, the minimum value of the weighting coefficient may be 0.

Moreover, the storage unit 40 may previously store a result of performing statistical processing of a plurality of pieces of appearance information, for example, an average value. In this case, the read-out unit 130 reads the result of the statistical processing from the storage unit 40. Then, the execution unit 140 assesses whether a difference between the result of the statistical processing and the appearance information of the product based on the first image acquired by the second acquisition unit 120 satisfies the first criterion.

Moreover, when information stored in the storage unit 40 satisfies the second criterion, at least one of read-out processing of appearance information by the read-out unit 130 and processing by the execution unit 140 may be performed. Herein, processing performed by the execution unit 140 is at least one of computation processing of a difference between two pieces of appearance information and the first processing. In other words, when the second criterion is not satisfied, at least first processing reading necessity is not assessed.

The second criterion is set in order to heighten accuracy of assessment by the execution unit 140, i.e. accuracy of assessment of whether a product relevant to appearance information read by the read-out unit 130 and a product included in the first image acquired by the second acquisition unit 120 are different. One example of the second criterion is at least one of (1) and (2) below.
(1) Pieces of appearance information relevant to product identification information acquired by the first acquisition unit 110 are stored in the storage unit 40 equal to or more than a first number. The first number is equal to or more than 2, but is preferably equal to or more than 10. In this way, accuracy of assessment by the execution unit 140 becomes higher.
(2) Statistical information in a feature value space of a plurality of pieces of appearance information satisfies a third criterion. The third criterion means that there is a little noise included in the plurality of pieces of appearance information. An example of the third criterion is, for example, as above, but is not limited thereto.
Variance of positions of a plurality of pieces of appearance information in a feature value space is equal to or more than a first criterion value and equal to or less than a second criterion value. A fact that variance is equal to or more than the first criterion value indicates that appearance information having a sufficient number of pieces of appearance information are collected. A fact that variance is equal to or less than the second criterion value means that there is a little noise included in a plurality of pieces of appearance information.
Variance of each of a plurality of feature quantities is equal to or more than the third criterion value and equal to or less than a fourth criterion value. The third criterion value has a similar meaning to the first criterion value described above, and the fourth criterion value has a similar meaning to the second criterion value described above. Herein, it is preferable that the third criterion value and the fourth criterion value are determined for each feature value.
An average position of a plurality of pieces of appearance information in a feature value space is computed, and pieces of present appearance information located within a predetermined distance from the average positions exist equal to or more than a criterion number.

The update unit 150 updates the storage unit 40. For example, the update unit 150 updates the storage unit 40 by use of the product identification information acquired by the first acquisition unit 110 and the first image acquired by the second acquisition unit 120. An example of processing performed by the update unit 150 is at least one of (A) to (D) below. Note that, in each example, the storage unit 40 stores a plurality of pieces of appearance information for one piece of product identification information.
(A) The update unit 150 adds appearance information based on the first image newly acquired by the second acquisition unit 120, to the storage unit 40 in association with the product identification information acquired by the first acquisition unit 110.
(B) When the imaging apparatus 30 is constantly operating, an image acquired by the second acquisition unit 120 also includes an image other than the first image, i.e. an image generated at timing when the reading apparatus 20 does not read product identification information. At least a part of the images includes a product for which the reading apparatus 20 has read product identification information. Hereinafter, this image is referred to as a second image. The update unit 150 updates the storage unit 40 by use of the second image. Specifically, the update unit 150 processes a plurality of images generated by the imaging apparatus 30, tracks the product for which the reading apparatus 20 has read product identification information, and determines a second image by use of a result of the tracking. Then, the update unit 150 generates appearance information of the second image, and adds the appearance information to the storage unit 40 in association with the product identification information acquired by the first acquisition unit 110. The second image may be generated before the first image, or may be generated after the first image.

Note that, an orientation of a product when the product identification information is read into the read-out unit 130 is almost the same. Thus, orientations of products are similar to each other within a plurality of first images. Therefore, when the processing illustrated in (B) is not performed, there is a high possibility that a plurality of pieces of appearance information stored in the storage unit 40 are similar to each other. On the other hand, there is a possibility that an orientation of a product within the second image is different from an orientation of a product within the first image. Thus, when the processing illustrated in (B) is performed, there is a high possibility that some of pieces of appearance information stored in the storage unit 40 is different from others. In other words, a variation of appearance information stored in the storage unit 40 increases.
(C) The update unit 150 disables appearance information satisfying the fourth criterion in a feature value space. The fourth criterion indicates that there is a high possibility that the appearance information is noise. One example of noise is such a case that a large portion of a product is hidden by a hand. Herein, the update unit 150 may delete the appearance information satisfying the fourth criterion, or may attach a flag to the appearance information satisfying the fourth criterion. Note that, an example of the fourth criterion is at least one of (C-1) and (C-2) below.
(C-1) The appearance information exists in a region where density is equal to or less than a criterion value in a feature value space.

When a plurality of pieces of appearance information indicate the same product, the pieces of appearance information are close to each other in the feature value space. In other words, in a region corresponding to correct appearance information, density of appearance information should be equal to or more than the criterion value. Then, there is a high possibility that appearance information located outside the region is noise.
(C-2) A distance from an average position of a plurality of pieces of appearance information to the appearance information in a feature value space is equal to or more than a criterion value.

As described above, when a plurality of pieces of appearance information indicate the same product, the pieces of appearance information are close to each other in a feature value space. Thus, the average position of the plurality of pieces of appearance information should indicate standard appearance information of the product. Then, there is a high possibility that appearance information being away from the average position equal to or more than a criterion value is noise.
(D) When appearance information stored in the storage unit 40 regarding product identification information exceeds a second number being a value larger than the first number, appearance information being farthest from an average position of a plurality of pieces of appearance information in a feature value space is deleted.

When appearance information stored in the storage unit 40 is too much, there is a possibility that a computation amount required for the execution unit 140 becomes too large. Thus, when the update unit 150 performs processing illustrated in (D), the number of pieces of appearance information stored in the storage unit 40 becomes equal to or less than the second number regarding one piece of product identification information.

Note that, instead of performing the processing illustrated in (D), the update unit 150 may not perform update processing of the storage unit 40 regarding the product.

The payment unit 160 performs payment processing by use of registration information generated by the first acquisition unit 110, i.e., a list of product identification information of a product to be a payment target. In this instance, the payment unit 160 uses information stored in the storage unit 40.

Herein, in a case where there is one product to be a payment target, it is preferable that the payment unit 160 performs payment processing of the product when the first criterion is not satisfied, or when the second criterion is satisfied. Moreover, in a case where there are a plurality of products to be payment targets, it is preferable that the payment unit 160 performs payment processing when the first criterion described above is not satisfied regarding all products, or when the second criterion is satisfied regarding at least one product.

When the first criterion is not satisfied, it is indicated that there is a high possibility that a product relevant to appearance information read by the read-out unit 130 and the product included in the first image acquired by the second acquisition unit 120 match.

Moreover, when the second criterion is satisfied, the storage unit 40 stores a sufficient number of appearance information. In this case, accuracy of determination by the execution unit 140, i.e., accuracy of determination of whether a product relevant to the appearance information read by the read-out unit 130 and a product included in the first image acquired by the second acquisition unit 120 are different becomes sufficiently high.

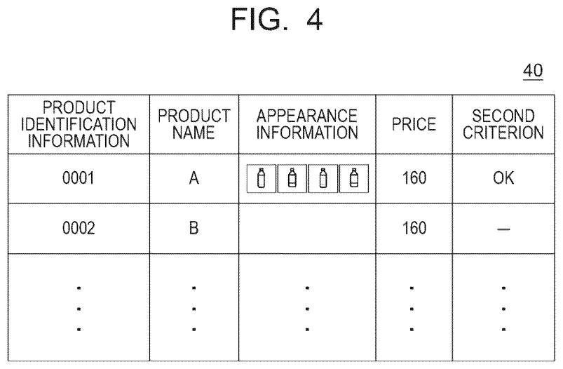

FIG. 4 is a diagram illustrating one example of information stored in the storage unit 40. The storage unit 40 stores, for each product, product identification information, a product name, a plurality of pieces of appearance information, and a price. In the example illustrated in the present figure, the storage unit 40 further stores information indicating whether the product satisfies the second criterion. Thus, the payment unit 160 can easily determine whether the product satisfies the second criterion.

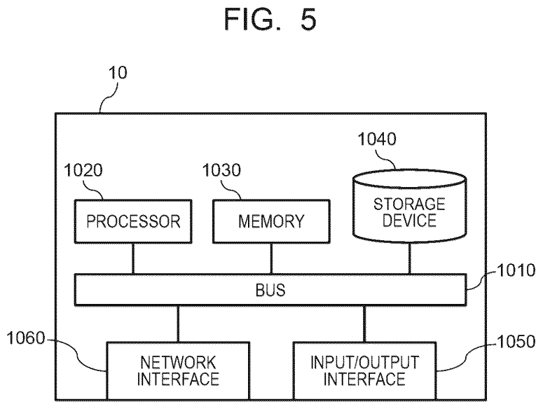

FIG. 5 is a diagram illustrating a hardware configuration example of the product confirmation apparatus 10. The product confirmation apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit and receive data to and from each other. However, a method of connecting the processor 1020 and the like to each other is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a removable medium such as a hard disk drive (HDD), a solid state drive (SSD), or a memory card, a read only memory (ROM), or the like, and has a recording medium. A storage medium of the storage device 1040 stores a program module that achieves each function (e.g. the first acquisition unit 110, the second acquisition unit 120, the read-out unit 130, the execution unit 140, the update unit 150, and the payment unit 160) of the product confirmation apparatus 10. The processor 1020 reads each of the program modules onto the memory 1030, executes the read program module, and thereby achieves each function being associated with the program module. Moreover, the storage device 1040 may also function as the storage unit 40.

The input/output interface 1050 is an interface for connecting the product confirmation apparatus 10 to various kinds of input/output equipment. For example, the product confirmation apparatus 10 communicates with the reading apparatus 20 and the imaging apparatus 30 through the input/output interface 1050.

The network interface 1060 is an interface for connecting the image display apparatus 10 to a network. The network is, for example, a local area network (LAN) or a wide area network (WAN). A method of connecting the network interface 1060 to the network may be wireless connection, or may be wired connection. The product confirmation apparatus 10 may communicate with at least one of the reading apparatus 20 and the imaging apparatus 30 through the network interface 1060.

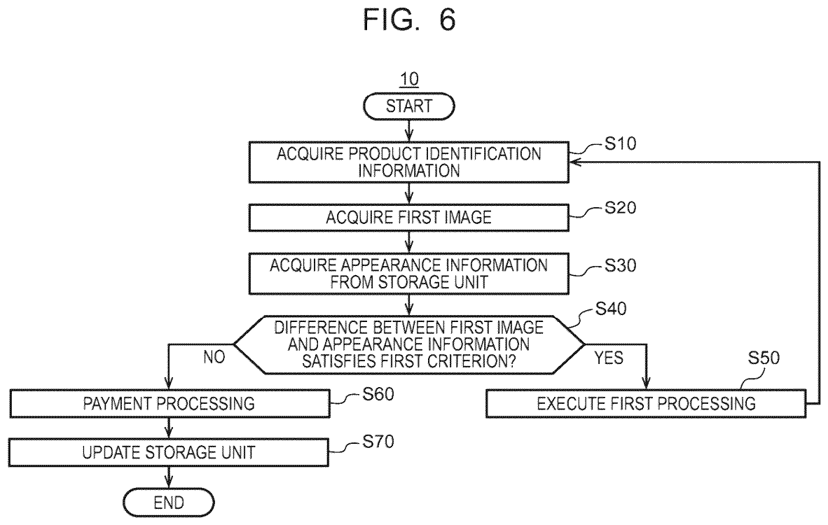

FIG. 6 is a flowchart illustrating one example of processing performed by the product confirmation apparatus 10. When purchasing a product, a customer or a person working in an office causes the reading apparatus 20 to read product identification information of the product. The first acquisition unit 110 of the product confirmation apparatus 10 acquires the product identification information (step S10). Moreover, the second acquisition unit 120 of the product confirmation apparatus 10 acquires a first image generated by the imaging apparatus 30. A determination method and an acquisition method of the first image is as described by use of FIG. 3 (step S20).

The read-out unit 130 of the product confirmation apparatus 10 reads, from the storage unit 40, appearance information relevant to the product identification information acquired in step S10 (step S30).

The execution unit 140 determines appearance information based on the first image. Then, the execution unit 140 determines whether a difference between the appearance information and the appearance information read in step S30 satisfies a first criterion (step S40). When the first criterion is satisfied, there is a possibility that a product indicated by the product identification information acquired in step S10 and a product included in the first image are different, and, therefore, first processing, for example, output processing of warning information is performed (step S50).

On the other hand, when the first criterion is not satisfied, the payment unit 160 performs payment processing by use of the product identification information acquired by the first acquisition unit 110 (step S60). Moreover, the update unit 150 updates the storage unit 40 by use of the product identification information acquired in step S10 and the first image acquired in step S20 (step S70). A specific example of update processing performed herein is as described by use of FIG. 3.

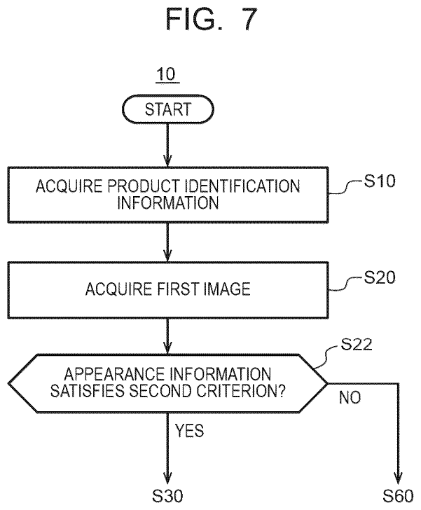

FIG. 7 is a diagram illustrating a modified example of FIG. 6. In the example illustrated in the present figure, the storage unit 40 stores, for each product, information indicating whether the product satisfies a second criterion. Then, after step S20, the product confirmation apparatus 10 determines whether the product relevant to the product identification information acquired in step S10 satisfies the second criterion (step S22). A specific example of the second criterion is as described by use of FIG. 3. Satisfying the second criterion means that an amount and quality of appearance information stored in the storage unit 40 are sufficiently high. When the second criterion is satisfied (step S22: Yes), the product confirmation apparatus 10 performs processing in and after step S20. When the second criterion is not satisfied (step S22: No), the reading apparatus 20 advances to step S60, i.e. update processing of the storage unit 40, without performing processing illustrated in steps S30 to S50.

As described above, according to the present example embodiment, the execution unit 140 executes first processing, for example, warning processing when a difference between appearance information read from the storage unit 40 by the read-out unit 130 and appearance information of a product based on the first image acquired by the second acquisition unit 120 satisfies the first criterion. Thus, a customer or a manager (e.g. a clerk) of a product can recognize that there is a possibility that product identification information read by the reading apparatus 20 and a product included in the first image are different.

Moreover, at least a part of pieces of information stored in the storage unit 40 is generated by use of product identification information acquired by a first acquisition unit and a first image acquired by a second acquisition unit. Thus, effort when storing appearance information and product identification information in the storage unit 40 is less.

Moreover, the product confirmation apparatus 10 includes the update unit 150. The update unit 150 updates the storage unit 40 by use of product identification information acquired by the first acquisition unit and a first image acquired by the second acquisition unit. Therefore, effort when updating the storage unit 40 is less.

The example embodiments of the present invention have been described above with reference to the drawings, but are exemplifications of the present invention, and various configurations other than those described above can also be adopted.

Moreover, although a plurality of processes (pieces of processing) are described in order in a plurality of flowcharts used in the above description, an execution order of processes executed in each example embodiment is not limited to the described order. In each example embodiment, an order of illustrated processes can be changed to an extent that causes no problem in terms of content. Moreover, at least one process may be performed by another actor, for example, another apparatus or person. Moreover, each of the example embodiments described above can be combined to an extent that content does not contradict.

Some or all of the above-described example embodiments can also be described as, but are not limited to, the following supplementary notes.
1. A product confirmation apparatus including:
   a first acquisition unit that acquires, from a product to be a payment target, product identification information of the product through a reading apparatus;
   a second acquisition unit that acquires a first image being an image generated when the reading apparatus reads the product identification information, and including the product;
   a read-out unit that reads, from a storage unit storing appearance information indicating an appearance of the product and the product identification information of the product in association with each other, the appearance information relevant to the product identification information acquired by the first acquisition unit; and
   an execution unit that executes first processing when a difference between the appearance information read by the read-out unit and appearance information of the product based on the first image acquired by the second acquisition unit satisfies a first criterion, wherein
   at least a part of pieces of information stored in the storage unit is generated by use of the product identification information acquired by the first acquisition unit and the first image acquired by the second acquisition unit.
2. The product confirmation apparatus according to supplementary note 1, further including
   an update unit that updates the storage unit by use of the product identification information acquired by the first acquisition unit and the first image acquired by the second acquisition unit.
3. The product confirmation apparatus according to supplementary note 2, wherein
   the update unit causes the storage unit to store a plurality of pieces of the appearance information regarding the one product, and
   at least one of reading processing by the read-out unit and the first processing by the execution unit is performed when information stored in the storage unit satisfies a second criterion.
4. The product confirmation apparatus according to supplementary note 3, wherein
   the second criterion includes a fact that pieces of the appearance information relevant to the product identification information acquired by the first acquisition unit are stored in the storage unit equal to or more than a first number.
5. The product confirmation apparatus according to supplementary note 3 or 4, wherein
   the second criterion includes a fact that statistical information in a feature value space of the plurality of pieces of appearance information satisfies a third criterion.
6. The product confirmation apparatus according to any one of supplementary notes 3 to 5, further including
   a payment unit that performs payment processing of the product when the first criterion is not satisfied or when the second criterion is satisfied.
7. The product confirmation apparatus according to any one of supplementary notes 2 to 6, wherein
   the update unit disables the appearance information satisfying a fourth criterion in a feature value space.
8. The product confirmation apparatus according to supplementary note 7, wherein
   the fourth criterion is at least one of a fact that the appearance information exists in a region where density is equal to or less than a criterion value in the feature value space, and a fact that a distance from an average position of the plurality of pieces of appearance information to the appearance information in the feature value space is equal to or more than a criterion value.
9. The product confirmation apparatus according to any one of supplementary notes 2 to 8, wherein
   the second acquisition unit also acquires a second image being an image generated at timing when the reading apparatus does not read the product identification information, and being an image capturing the product for which the reading apparatus has read the product identification information, and
   the update unit updates the storage unit by use of the second image.
10. The product confirmation apparatus according to any one of supplementary notes 1 to 9, wherein
   the first processing is output processing of warning information.
11. A product confirmation method including,
   by a computer:
      acquiring, from a product to be a payment target, product identification information of the product through a reading apparatus;
      acquiring a first image being an image generated when the reading apparatus reads the product identification information, and including the product;
      reading, from a storage unit storing appearance information indicating an appearance of the product and the product identification information of the product in association with each other, the appearance information relevant to the product identification information acquired by the computer; and
      executing first processing when a difference between the appearance information read by the computer and appearance information of the product based on the first image acquired by the computer satisfies a first criterion, wherein
   at least a part of pieces of information stored in the storage unit is generated by use of the product identification information acquired by the computer and the first image acquired by the computer.
12. The product confirmation method according to supplementary note 11, further including
   by the computer,
   updating the storage unit by use of the acquired product identification information and the first image acquired by the computer.
13. The product confirmation method according to supplementary note 12, further including
   by the computer:
   causing the storage unit to store a plurality of pieces of the appearance information regarding the one product; and
   performing at least one of reading processing of the appearance information and the first processing when information stored in the storage unit satisfies a second criterion.
14. The product confirmation method according to supplementary note 13, wherein
   the second criterion includes a fact that pieces of the appearance information relevant to the product identification information acquired by the computer are stored in the storage unit equal to or more than a first number.
15. The product confirmation method according to supplementary note 13 or 14, wherein
   the second criterion includes a fact that statistical information in a feature value space of the plurality of pieces of appearance information satisfies a third criterion.
16. The product confirmation method according to any one of supplementary notes 13 to 15, further including
   by the computer,
   performing payment processing of the product when the first criterion is not satisfied or when the second criterion is satisfied.
17. The product confirmation method according to any one of supplementary notes 12 to 16, further including
   by the computer,
   disabling the appearance information satisfying a fourth criterion in a feature value space.
18. The product confirmation method according to supplementary note 17, wherein
   the fourth criterion is at least one of a fact that the appearance information exists in a region where density is equal to or less than a criterion value in the feature value space, and a fact that a distance from an average position of the plurality of pieces of appearance information to the appearance information in the feature value space is equal to or more than a criterion value.
19. The product confirmation method according to any one of supplementary notes 12 to 18, further including,
   by the computer:
      also acquiring a second image being an image generated at timing when the reading apparatus does not read the product identification information, and being an image capturing the product for which the reading apparatus has read the product identification information; and
      updating the storage unit by use of the second image.
20. The product confirmation method according to any one of supplementary notes 11 to 19, wherein
   the first processing is output processing of warning information.
21. A storage medium storing a program executable by a computer,
   the program causing the computer to include:
      a first acquisition function of acquiring, from a product to be a payment target, product identification information of the product through a reading apparatus;
      a second acquisition function of acquiring a first image being an image generated when the reading apparatus reads the product identification information, and including the product;
      a read-out function of reading, from a storage unit storing appearance information indicating an appearance of the product and the product identification information of the product in association with each other, the appearance information relevant to the product identification information acquired by the first acquisition function; and
      an execution function of executing first processing when a difference between the appearance information read by the read-out function and appearance information of the product based on the first image acquired by the second acquisition function satisfies a first criterion, wherein
   at least a part of pieces of information stored in the storage unit is generated by use of the product identification information acquired by the first acquisition function and the first image acquired by the second acquisition function.
22. The storage medium according to supplementary note 21, wherein
   the program causes the computer to include
      an update function of updating the storage unit by use of the product identification information acquired by the first acquisition function and the first image acquired by the second acquisition function.
23. The storage medium according to supplementary note 22, wherein
   the update function causes the storage unit to store a plurality of pieces of the appearance information regarding the one product, and
   at least one of reading processing by the read-out function and the first processing by the execution function is performed when information stored in the storage unit satisfies a second criterion.
24. The storage medium according to supplementary note 23, wherein
   the second criterion includes a fact that pieces of the appearance information relevant to the product identification information acquired by the first acquisition function are stored in the storage unit equal to or more than a first number.
25. The storage medium according to supplementary note 23 or 24, wherein
   the second criterion includes a fact that statistical information in a feature value space of the plurality of pieces of appearance information satisfies a third criterion.
26. The storage medium according to any one of supplementary notes 23 to 25, wherein
   the program causes the computer to include
      a payment function of performing payment processing of the product when the first criterion is not satisfied or when the second criterion is satisfied.
27. The storage medium according to any one of supplementary notes 22 to 26, wherein
   the update function disables the appearance information satisfying a fourth criterion in a feature value space.
28. The storage medium according to supplementary note 27, wherein
   the fourth criterion is at least one of a fact that the appearance information exists in a region where density is equal to or less than a criterion value in the feature value space, and a fact that a distance from an average position of the plurality of pieces of appearance information to the appearance information in the feature value space is equal to or more than a criterion value.
29. The storage medium according to any one of supplementary notes 22 to 28, wherein
   the second acquisition function also acquires a second image being an image generated at timing when the reading apparatus does not read the product identification information, and being an image capturing the product for which the reading apparatus has read the product identification information, and
   the update function updates the storage unit by use of the second image.
30. The storage medium according to any one of supplementary notes 21 to 29, wherein
   the first processing is output processing of warning information.
31. A program according to any one of supplementary notes 21 to 30.

### REFERENCE SIGNS LIST

10 Product confirmation apparatus
20 Reading apparatus
30 Imaging apparatus
40 Storage unit
110 First acquisition unit
120 Second acquisition unit
130 Read-out unit
140 Execution unit
150 Update unit
160 Payment unit

What is claimed is:

1. A product confirmation apparatus comprising:
at least one memory storing instructions; and
at least one processor configured to execute the instructions to:
acquire, from a product to be a payment target, product identification information of the product through a reading apparatus;
acquire a first image being an image generated when the reading apparatus reads the product identification information, and including the product;
read, from a storage unit storing appearance information indicating an appearance of the product and the product identification information of the product in association with each other, the appearance information relevant to the product identification information acquired and
execute first processing when a difference between the appearance information read and appearance information of the product based on the first image acquired satisfies a first criterion, wherein
at least a part of pieces of information stored in the storage unit is generated by use of the product identification information acquired and the first image acquired.

2. The product confirmation apparatus according to claim 1, wherein the at least one processor is further configured to execute the instructions to
update the storage unit by use of the product identification information acquired and the first image acquired.

3. The product confirmation apparatus according to claim 2, wherein the at least one processor is further configured to execute the instructions to
cause the storage unit to store a plurality of pieces of the appearance information regarding the one product, and
at least one of reading processing of reading the appearance information and the first processing is performed when information stored in the storage unit satisfies a second criterion.

4. The product confirmation apparatus according to claim 3, wherein
the second criterion includes a fact that pieces of the appearance information relevant to the product identification information acquired are stored in the storage unit equal to or more than a first number.

5. The product confirmation apparatus according to claim 3, wherein
the second criterion includes a fact that statistical information in a feature value space of the plurality of pieces of appearance information satisfies a third criterion.

6. The product confirmation apparatus according to claim 3, wherein the at least one processor is further configured to execute the instructions to
perform payment processing of the product when the first criterion is not satisfied or when the second criterion is satisfied.

7. The product confirmation apparatus according to claim 2, wherein the at least one processor is further configured to execute the instructions to
disable the appearance information satisfying a fourth criterion in a feature value space.

8. The product confirmation apparatus according to claim 7, wherein
the fourth criterion is at least one of a fact that the appearance information exists in a region where density is equal to or less than a criterion value in the feature value space, and a fact that a distance from an average position of the plurality of pieces of appearance information to the appearance information in the feature value space is equal to or more than a criterion value.

9. The product confirmation apparatus according to claim 2, wherein the at least one processor is further configured to execute the instructions to:
also acquire second image being an image generated at timing when the reading apparatus does not read the product identification information, and being an image capturing the product for which the reading apparatus has read the product identification information; and
update the storage unit by use of the second image.

10. The product confirmation apparatus according to claim 1, wherein
the first processing is output processing of warning information.

11. A product confirmation method comprising,
by a computer:
acquiring, from a product to be a payment target, product identification information of the product through a reading apparatus;
acquiring a first image being an image generated when the reading apparatus reads the product identification information, and including the product;
reading, from a storage unit storing appearance information indicating an appearance of the product and the product identification information of the product in association with each other, the appearance information relevant to the product identification information acquired by the computer; and
executing first processing when a difference between the appearance information read by the computer and appearance information of the product based on the first image acquired by the computer satisfies a first criterion, wherein
at least a part of pieces of information stored in the storage unit is generated by use of the product identification information acquired by the computer and the first image acquired by the computer.

12. A non-transitory computer-readable storage medium storing a program executable by a computer,
the program causing the computer to perform:
acquiring, from a product to be a payment target, product identification information of the product through a reading apparatus;
acquiring a first image being an image generated when the reading apparatus reads the product identification information, and including the product;
reading, from a storage unit storing appearance information indicating an appearance of the product and the product identification information of the product in association with each other, the appearance information relevant to the product identification information acquired; and
executing first processing when a difference between the appearance information read and appearance information of the product based on the first image acquired satisfies a first criterion, wherein
at least a part of pieces of information stored in the storage unit is generated by use of the product identification information acquired and the first image acquired.
